(19) United States
(12) Patent Application Publication
(10) Pub. No.: US 2008/0266104 A1
(43) Pub. Date: Oct. 30, 2008

(54) RADIO FREQUENCY IDENTIFICATION DEVICES

(75) Inventors: Shin-Chang Chen, Taipei City (TW); Shyh-Jong Chung, Hsinchu City (TW); Ya-Ping Chen, Kaohsiung County (TW); Yung-Chih Lo, Changhua County (TW)

Correspondence Address: Akin Gump LLP - Silicon Valley, 3000 El Camino Real, Two Palo Alto Square, Suite 400, Palo Alto, CA, 94306, US

(73) Assignee: INDUSTRIAL TECHNOLOGY RESEARCH INSTITUTE, Chutung (TW)

(21) Appl. No.: 11/742,560

(22) Filed: Apr. 30, 2007

(51) Int. Cl. G08B 13/14

(52) U.S. Cl. 340/572.7

(57) ABSTRACT

A radio frequency identification (RFID) device comprising a transmitter on a first surface of a substrate, a receiver on the first surface of the substrate, a ground area on a second surface of the substrate, a first antenna on the first surface of the substrate, the first antenna being electrically connected to the ground area and capable of transmitting outgoing signals, and a second antenna on the first surface of the substrate, the second antenna being electrically connected to the ground area and capable of receiving incoming signals.

### BACKGROUND OF THE INVENTION

The present invention generally relates to radio frequency identification (RFID) and, more particularly, to RFID readers including a double-antenna structure.

Radio frequency identification (RFID) is an important technology in the identification industry and has various applications. RFID tags or labels are widely used to associate an object with an identification code. For example, RFID tags have been used for inventory management, access control to buildings and security-locks in vehicles. Information stored on an RFID tag may identify an inventory item having a unique identification number or a person seeking access to a secured building. RFID tags can retain and transmit enough information to uniquely identify individuals, packages, inventory and the like. Generally, in an RFID system, in order to retrieve the information from an RFID tag, an RFID reader may send an excitation signal to the RFID tag at a small distance using radio frequency (RF) data transmission technology. The excitation signal may energize the tag, which in turn may transmit the stored information back to the reader. The RFID reader may then receive and decode the information from the RFID tag.

FIG. 1 is a schematic diagram of a conventional RFID reader 10. Referring to FIG. 1, the RFID reader 10 may generally include a receiver 11, a transmitter 12, a circulator 13 and an antenna 14. The antenna 14 may be coupled to the circulator 13 so that incoming signals received by the antenna 14 are directed by the circulator 13 to the receiver 12 and outgoing signals to be transmitted from the transmitter 12 are directed by the coupler 13 to the antenna 14. The circulator 13 may provide isolation effects of approximately 20 to 30 dB so as to prevent outgoing signals from entering the receiver 11. With the relatively high signal isolation effects, however, the circulator 13 may have a size of approximately 2.5×2.5 square centimeters. Furthermore, the antenna 14 may even have a size of 10×10 square centimeters. Such dimensions of the circulator 13 and antenna 14 may hinder the RFID reader 10 from compactness and low-profile. With the increasing interest in portable or hand-held RFID readers, it may be desirable for the components and devices thereof to be manufactured with minimum feature size so as to meet the requirements for mobility.

### BRIEF SUMMARY OF THE INVENTION

Examples of the present invention may provide a radio frequency identification (RFID) device comprising a transmitter on a first surface of a substrate, a receiver on the first surface of the substrate, a ground area on a second surface of the substrate, a first antenna on the first surface of the substrate, the first antenna being electrically connected to the ground area and capable of transmitting outgoing signals, and a second antenna on the first surface of the substrate, the second antenna being electrically connected to the ground area and capable of receiving incoming signals.

Examples of the present invention may provide a radio frequency identification (RFID) device comprising a first antenna on a first surface of a substrate, a transmitter on the first surface of the substrate, the transmitter being capable of transmitting signals through the first antenna, a second antenna on the first surface of the substrate, the second antenna being separated from the first antenna and exhibiting a coupling impedance with the first antenna, a receiver on the first surface of the substrate, the receiver being capable of receiving signals from the second antenna, and a circuit capable of providing an impedance to substantially cancel the coupling impedance.

Examples of the present invention may provide a radio frequency identification (RFID) device comprising a first antenna on a first surface of a substrate, the first antenna being capable of transmitting outgoing signals, a second antenna on the first surface of the substrate, the second antenna being capable of receiving incoming signals, the second antenna being separated from the first antenna and exhibiting a coupling impedance with the first antenna, and a circuit capable of providing an impedance to substantially cancel the coupling impedance.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings examples which are presently preferred. It should be understood, however, that the invention is not limited to the precise arrangements and instrumentalities shown.

In the drawings:

FIG. 1 is a schematic diagram of a conventional radio frequency identification (RFID) reader;

FIGS. 2A and 2B are schematic plan views showing respectively a top surface and a bottom surface an RFID reader consistent with an example of the present invention;

FIG. 2C is a schematic cross-sectional view of the RFID reader illustrated in FIGS. 2A and 2B;

FIG. 3A is a diagram illustrating an equivalent circuit model for a double-antenna structure;

FIG. 3B is a diagram illustrating an equivalent circuit model for an RFID reader consistent with an example of the present invention;

FIG. 4A is an exemplary plot illustrating the scattering parameters (S-parameters) for the circuit model illustrated in FIG. 3A;

FIG. 4B is an exemplary plot illustrating the S-parameters for the circuit model illustrated in FIG. 3B;

FIG. 5A is a schematic circuit diagram of a conventional circuit capable of providing a negative resistance;

FIG. 5B is a schematic plot illustrating current-voltage (I-V) characteristic of the circuit illustrated in FIG. 5A;

FIG. 6A is a circuit diagram of a circuit capable of impedance matching consistent with an example of the present invention; and

FIG. 6B is a circuit diagram of a circuit capable of impedance matching consistent with another example of the present invention.

### DETAILED DESCRIPTION OF THE INVENTION

Reference will now be made in detail to the present examples of the invention illustrated in the accompanying drawings. Wherever possible, the same reference numbers will be used throughout the drawings to refer to the same or like portions.

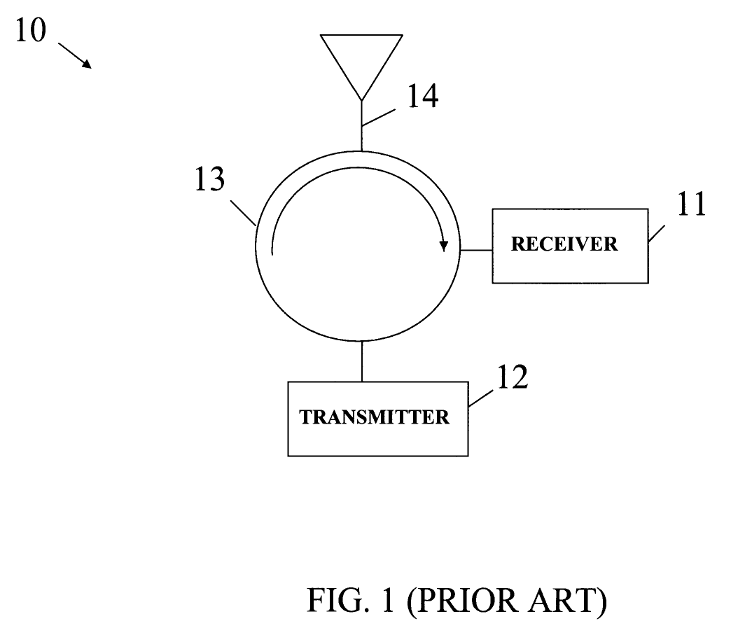

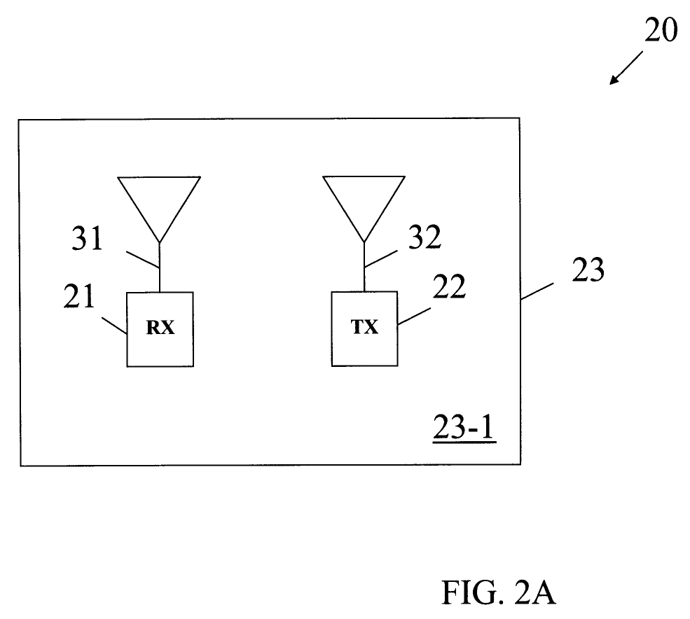

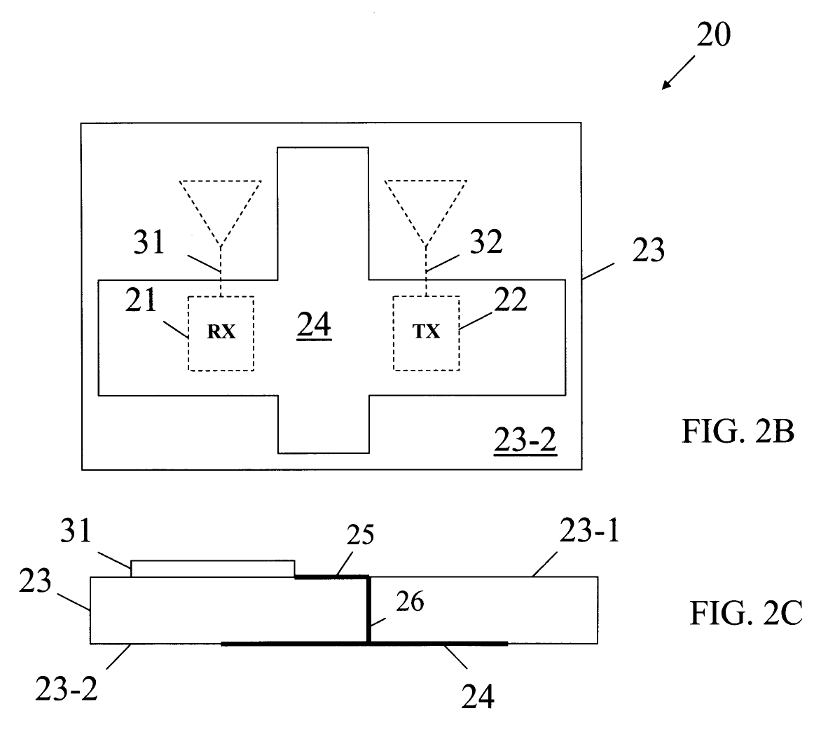

FIGS. 2A and 2B are schematic plan views showing respectively a top surface and a bottom surface an RFID reader 20 consistent with an example of the present invention. Referring to FIG. 2A, the RFID reader 20 may include a receiver 21, a transmitter 22, a first antenna 31 capable of receiving incoming signals and a second antenna 32 capable of transmitting outgoing signals. The receiver 21, transmitter 22, first antenna 31 and second antenna 32 may be formed on a first surface 23-1 of a substrate 23 such as a printed circuit board. The double-antenna structure of the RFID reader 20 eliminates a circulator such as the circulator 13 illustrated in FIG. 1, and thereby may facilitate downsizing the RFID reader 20. Each of the first antenna 31 and the second antenna 32 in one example may include one of a chip antenna and a planar antenna, which may further facilitate downsizing the RF reader 20. The chip antenna may include a ceramic chip antenna such as a low temperature co-fired ceramic (LTCC) chip antenna, which may be available from, for example, Rainsun Corporation (Taiwan). The planar antenna may include a printed antenna, a microstrip antenna and a patched inverse-F antenna (PIFA).

Skilled persons in the art will understand that the distance between the first antenna 31 and the second antenna 32 may affect the radiation patterns of the antennas. Generally, the greater the distance, the better the isolation of the antennas and the less the mutual coupling effects on the antennas. On the other hand, however, the size of an RFID reader may increase as the distance between two antennas increases. It may be desirable to achieve optimal isolation under a given size limit. Given the fact that the RFID reader 20 has a size of approximately 3×3 square centimeters, in one example according to the present invention, each of the first antenna 31 and the second antenna 32, operating at a frequency of 915 mega Hertz (MHz), may be separated from one another by a distance of approximately 2.125 centimeter (cm).

Referring to FIG. 2B, a ground area 24 made of a conductive material such as metal may be formed on a second surface 23-2 of the substrate 23. The ground area 24 may alleviate coupling effects on the first antenna 31 and the second antenna 32. The coupling effects may adversely affect several characteristics of the antennas 31 and 32, including, for example, radiation pattern and antenna impedance.

FIG. 2C is a schematic cross-sectional view of the RFID reader 20 illustrated in FIGS. 2A and 2B. Referring to FIG. 2C, each of the first antenna 31 and the second antenna 32 on the first surface 23-1 may be electrically connected to the ground area 24 on the second surface 23-2 by a conductive trace 25 on the first surface 23-1 and a conductive via 26 through the substrate 23.

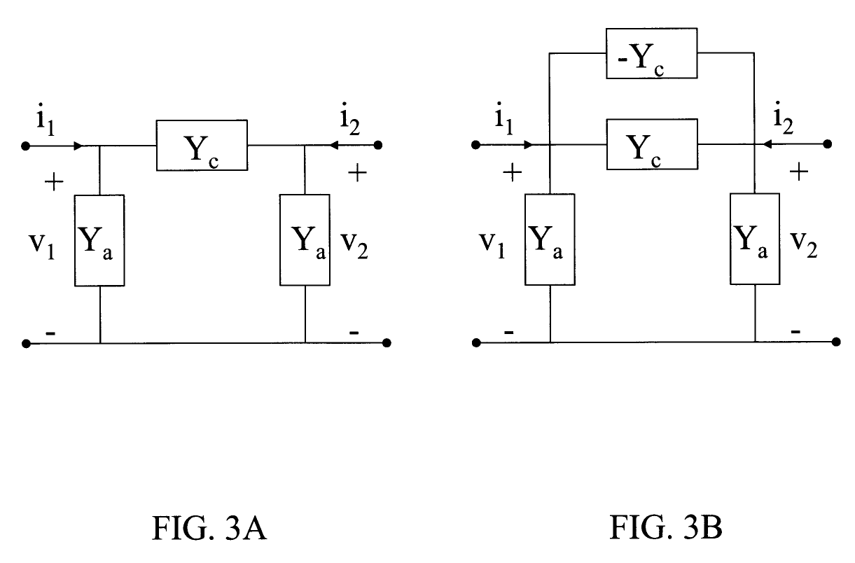

FIG. 3A is a diagram illustrating an equivalent circuit model for a double-antenna structure. At a given frequency, a double-antenna structure similar to that illustrated in FIG. 2A may be treated as a two-port passive network. Referring to FIG. 3A, in the circuit model, Ya may represent the admittance of a first antenna and a second antenna and Yc may represent a coupling admittance due to, for example, mutual coupling, between the first and second antennas. The values of Ya and Yc may vary as the distance between the first and second antennas varies. Furthermore, the Y-parameters, Y₁₁, Y₁₂, Y₂₁ and Y₂₂, for the circuit model may be defined as follows.

Y₁₁=i₁/v₁ with v₂=0 (i.e., the second antenna feedpoint is short-circuited)

Y₁₂=i₁/v₂ with v₁=0 (i.e., the first antenna feedpoint is short-circuited)

Y₂₁=i₂/v₁ with v₂=0

Y₂₂=i₂/v₂ with v₁=0

Note that for this circuit model Y₁₂=Y₂₁.

The relationship between the admittances Ya, Yc and the Y-parameters may be given below.

Y₁₁=Ya+Yc

Y₁₂=Y₂₁=−Yc

Y₂₂=Ya+Yc=Y₁₁

FIG. 3B is a diagram illustrating an equivalent circuit model for an RFID reader consistent with an example of the present invention. Referring to FIG. 3B, the circuit model may be similar to that illustrated in FIG. 3A except that, for example, a negative admittance −Yc is connected in parallel with the coupling admittance Yc to eliminate the coupling admittance Yc. To determine the value of Yc, in one example, the Y-parameters may be expressed in S-parameters to facilitate calculation.

Y₁₁=Z₀⁻¹[(1−S₁₁)(1+S₂₂)+S₁₂ S₂₁]/[(1+S₁₁)(1+S₂₂)−S₁₂ S₂₁]

Y₁₂=Z₀⁻¹[−2S₁₂]/[(1+S₁₁)(1+S₂₂)−S₁₂ S₂₁]

Y₂₁=Z₀⁻¹[−2S₂₁]/[(1+S₁₁)(1+S₂₂)−S₁₂ S₂₁]

Y₂₂=Z₀⁻¹[(1+S₁₁)(1−S₂₂)+S₁₂ S₂₁]/[(1+S₁₁)−(1+S₂₂)−S₁₂ S₂₁]

Wherein Z₀ is a characteristic impedance having a value of approximately 50 ohms, S₁₁ is the input port voltage reflection coefficient, S₁₂ is the reverse voltage gain, S₂₁ is the forward voltage gain, and S₂₂ is the output port voltage reflection coefficient. The advantage of S-parameters may lie in the complete description of the device performance at microwave frequencies as well as the ability to convert to other parameters such as hybrid (H) or admittance (Y) parameters.

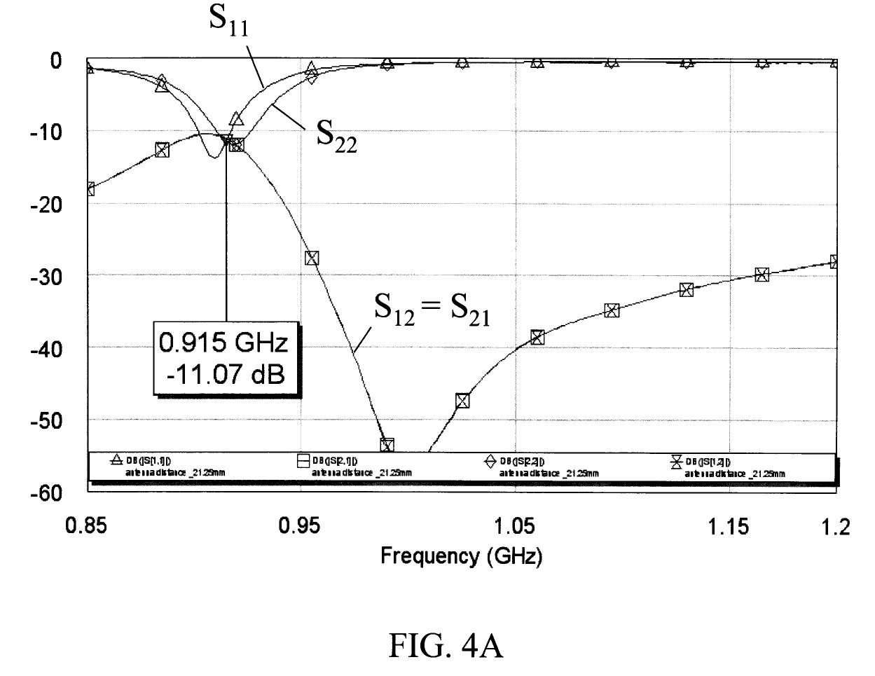

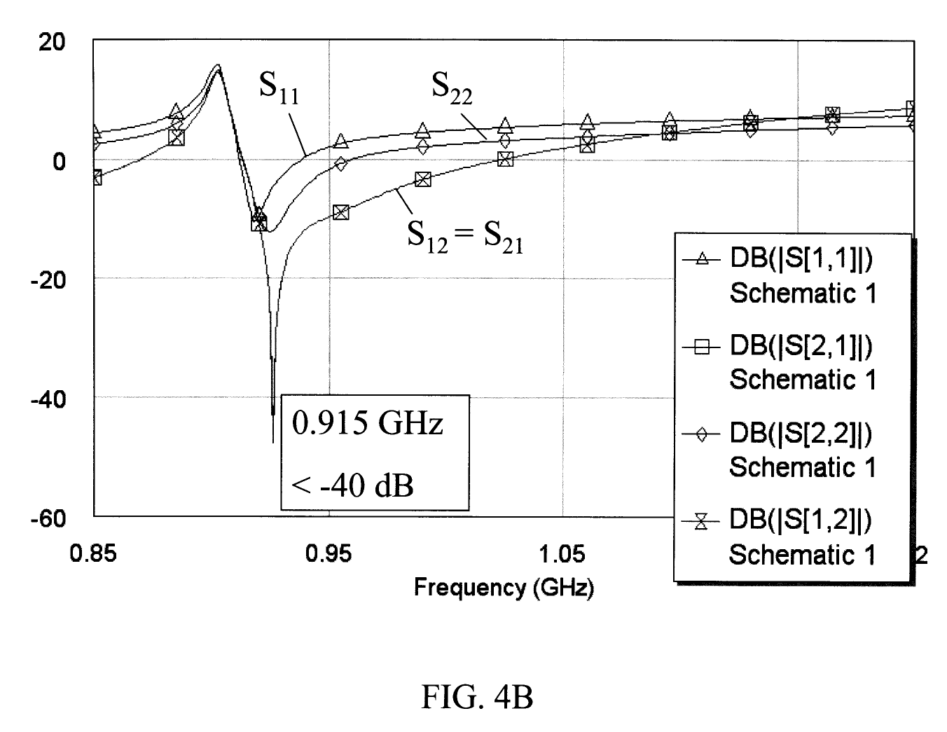

FIG. 4A is an exemplary plot illustrating the scattering parameters (S-parameters) for the circuit model illustrated in FIG. 3A. Referring to FIG. 4A, the S-parameters may be determined with the help of a spectrum analyzer such as, for example, the HFSS™ by the Ansoft Corporation (Pittsburgh, U.S.A.). The HFSS may support S-parameter extraction and three-dimensional (3D) electromagnetic-field simulation for high performance electronic design. For example, the HFSS may support the electromagnetic simulation of high-frequency and high-speed components, and has been widely used for the design of antennas and RF and/or microwave components as well as on-chip embedded passives, printed circuit board (PCB) interconnects and high-frequency integrated-circuit (IC) packages. Once the S-parameters are obtained, the Y-parameters and in turn the value of Yc may be obtained. Given an RFID reader having a size of approximately 3×3 square centimeters and the distance between antennas being approximately 2.125 cm, the value of Yc is approximately 66 ohms.

FIG. 4B is an exemplary plot illustrating the S-parameters for the circuit model illustrated in FIG. 3B. Referring to FIG. 3B, after the connection of a negative admittance of approximately −66 ohms, an electrical isolation greater than approximately 40 dB may be achieved, which shows a significant improvement as compared to the isolation of approximately 20 or 30 dB generally required for an RFID reader. The negative admittance may be provided by a non-linear circuit discussed below.

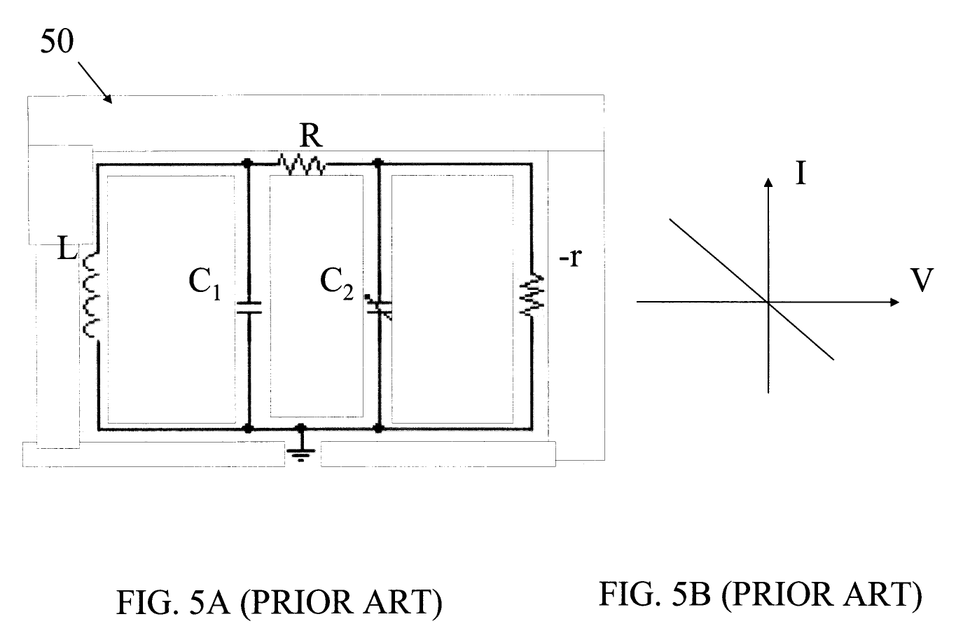

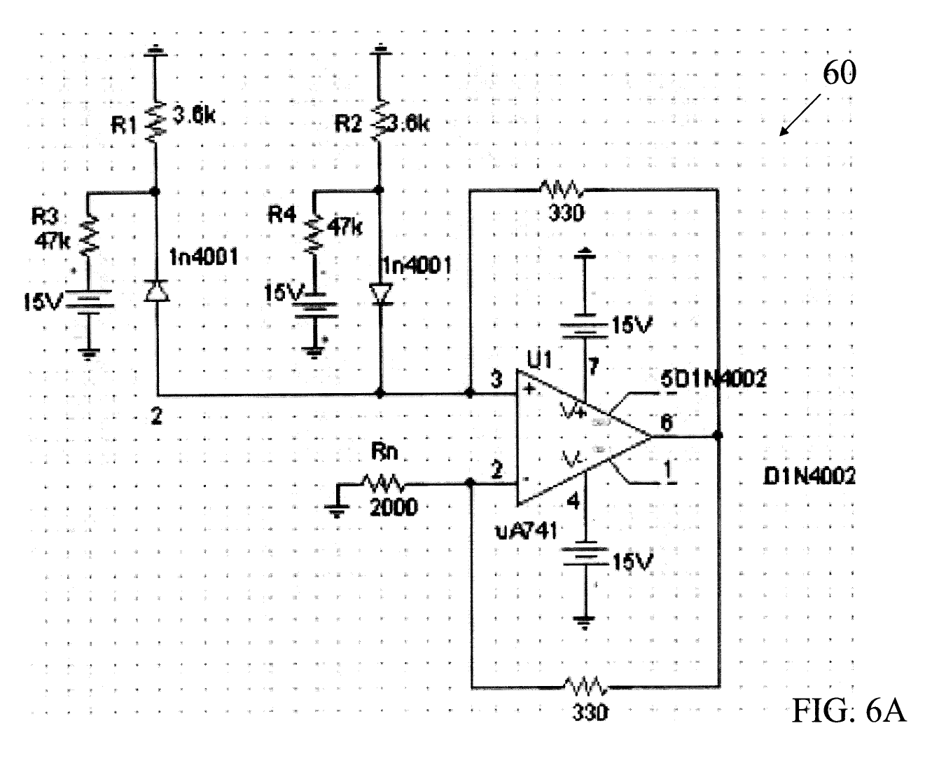

FIG. 5A is a schematic circuit diagram of a conventional circuit 50 capable of providing a negative resistance. Referring to FIG. 5A, the circuit 50, for example, a Chua's circuit, may include two capacitors C₁ and C₂, an inductor L and a non-linear resistor r. By varying the circuit parameters, a non-linear and chaotic phenomenon may be obtained. FIG. 5B is a schematic plot illustrating current-voltage (I-V) characteristic of the circuit 50 illustrated in FIG. 5A. Referring to FIG. 5B, the circuit 50 may provide a negative resistance region. The negative resistance or negative differential resistance may refer to a property of electrical circuit elements in which, over certain voltage ranges, current is a decreasing function of voltage. This range of voltage is known as a negative resistance region, which may be a non-linear region. Reference of the Chua's circuit may be made to “The Genesis of Chua's Circuit”, AEU 46, 250 (1992) by Leon Chua.

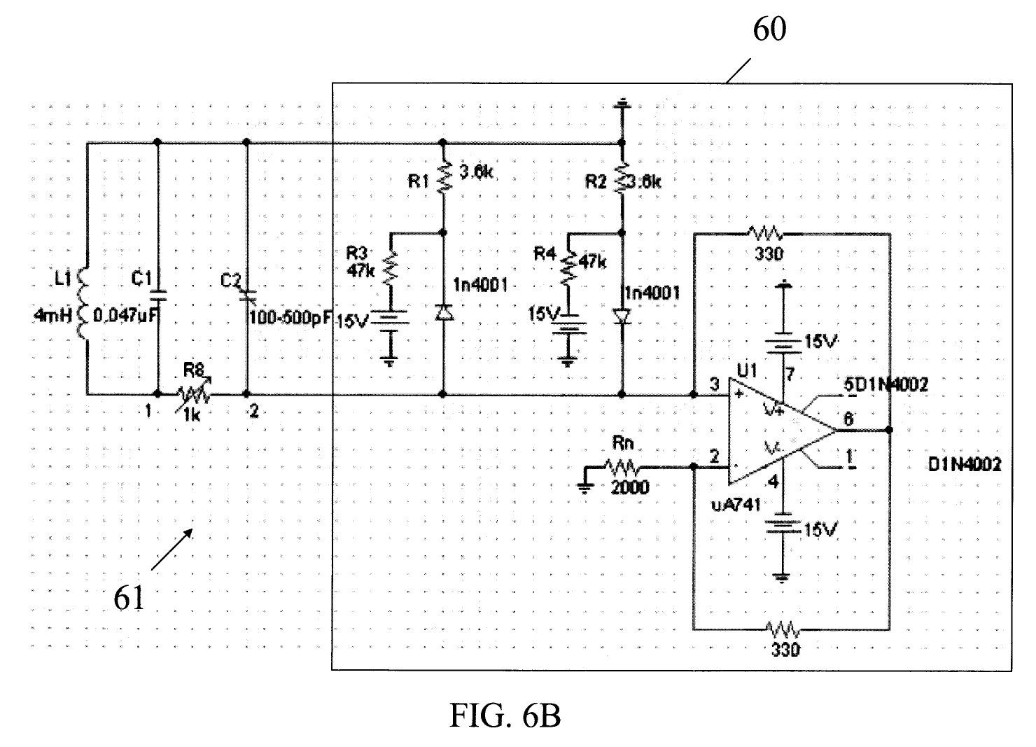

FIG. 6A is a circuit diagram of a circuit 60 capable of impedance matching consistent with an example of the present invention. Referring to FIG. 6A, the circuit 60 may include an operational amplifier such as, for example, uA741 and associated resistors and capacitors. FIG. 6B is a circuit diagram of a circuit 61 capable of impedance matching consistent with another example of the present invention. Referring to FIG. 6B, the circuit 61 may include a non-linear circuit similar to the circuit illustrate in FIG. 6A based on the Chua's circuit structure illustrated in FIG. 5A.

In describing representative examples of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

It will be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

We claim:

1. A radio frequency identification (RFID) device comprising:
a transmitter on a first surface of a substrate;
a receiver on the first surface of the substrate;
a ground area on a second surface of the substrate;
a first antenna on the first surface of the substrate, the first antenna being electrically connected to the ground area and capable of transmitting outgoing signals; and
a second antenna on the first surface of the substrate, the second antenna being electrically connected to the ground area and capable of receiving incoming signals.

2. The device of claim 1, wherein each of the first antenna and the second antenna includes one of a chip antenna and a planar antenna.

3. The device of claim 1, wherein each of the first antenna and the second antenna includes a low temperature co-fired ceramic (LTCC) chip antenna.

4. The device of claim 1, wherein each of the first antenna and the second antenna includes one of a microstrip antenna, a patched inverse-F antenna (PIFA) and a printed antenna.

5. The device of claim 1 further comprising a circuit capable of providing a negative resistance region.

6. The device of claim 5, wherein the circuit includes an operational amplifier.

7. The device of claim 5, wherein the first antenna and the second antenna are separated from one another by a distance of approximately 2 centimeters and the circuit is capable of providing an electrical isolation of approximately 40 dB at a frequency of approximately 915 mega Hertz (MHz).

8. A radio frequency identification (RFID) device comprising:
a first antenna on a first surface of a substrate;
a transmitter on the first surface of the substrate, the transmitter being capable of transmitting signals through the first antenna;
a second antenna on the first surface of the substrate, the second antenna being separated from the first antenna and exhibiting a coupling impedance with the first antenna;
a receiver on the first surface of the substrate, the receiver being capable of receiving signals from the second antenna; and
a circuit capable of providing an impedance to substantially cancel the coupling impedance.

9. The device of claim 8, wherein each of the first antenna and the second antenna includes one of a chip antenna and a planar antenna.

10. The device of claim 8, wherein each of the first antenna and the second antenna includes a low temperature co-fired ceramic (LTCC) chip antenna.

11. The device of claim 8, wherein each of the first antenna and the second antenna includes one of a microstrip antenna, a patched inverse-F antenna (PIFA) and a printed antenna.

12. The device of claim 8, wherein the circuit includes an operational amplifier.

13. The device of claim 8 further comprising a ground area on a second surface of the substrate.

14. The device of claim 13, wherein each of the first antenna and the second antenna is electrically connected to the ground area.

15. The device of claim 13, wherein the ground area includes a conductive metal.

16. A radio frequency identification (RFID) device comprising:
a first antenna on a first surface of a substrate, the first antenna being capable of transmitting outgoing signals;
a second antenna on the first surface of the substrate, the second antenna being capable of receiving incoming signals, the second antenna being separated from the first antenna and exhibiting a coupling impedance with the first antenna; and
a circuit capable of providing an impedance to substantially cancel the coupling impedance.

17. The device of claim 16, wherein each of the first antenna and the second antenna includes one of a chip antenna and a planar antenna.

18. The device of claim 16, wherein each of the first antenna and the second antenna includes a low temperature co-fired ceramic (LTCC) chip antenna.

19. The device of claim 16, wherein each of the first antenna and the second antenna includes one of a microstrip antenna, a patched inverse-F antenna (PIFA) and a printed antenna.

20. The device of claim 16, wherein the circuit includes an operational amplifier capable of providing a negative resistance region.

21. The device of claim 16 further comprising a ground area on a second surface of the substrate.

22. The device of claim 21, wherein each of the first antenna and the second antenna is electrically connected to the ground area.
